(19) United States
(12) Patent Application Publication
(10) Pub. No.: US 2020/0012296 A1
(43) Pub. Date: Jan. 9, 2020

(54) UNMANNED AERIAL VEHICLE LANDING AREA DETECTION

(71) Applicant: Intel Corporation, Santa Clara, CA (US)

(72) Inventors: Daniel Gurdan, Germering (DE); Mika Ritamaeki, Nokia (FI); Fabian Oberndorfer, Krailling (DE); Tobias Gurdan, Germering (DE); Evgeny Kalugin, Nokia (FI); Soren Friis, Kangasala (FI)

(21) Appl. No.: 16/551,759

(22) Filed: Aug. 27, 2019

(51) Int. Cl. G05D 1/06; B64C 39/02; B64F 1/00; B64D 45/08

(52) U.S. Cl. CPC G05D 1/0676; B64C 39/024; B64F 1/007; B64C 2201/18; B64C 2201/027; B64C 2201/141; B64D 45/08

(57) ABSTRACT

An unmanned aerial vehicle comprises an image sensor, configured to detect electromagnetic radiation and to generate image sensor data representing the detected electromagnetic radiation; a filter, configured to pass image sensor data representing one or more first wavelengths of electromagnetic radiation and to block image sensor data representing one or more second wavelengths of electromagnetic radiation; and one or more processors configured to determine from the passed image sensor data an origin of the detected electromagnetic radiation; and control the unmanned aerial vehicle to travel toward the determined origin.

### TECHNICAL FIELD

Various aspects relate generally to unmanned aerial vehicles (UAVs), their detection of a landing station, and their landing at the landing station.

### BACKGROUND

It is known to utilize one or more UAVs to perform a UAV light show. Existing versions of lightshow UAVs generally rely on Global Positioning System (GPS) coordinates to roughly detect a landing area, such as, for example, a landing station. Due at least to GPS drift, a UAV using only GPS coordinates to reach a landing station will often either land near, but not on, the landing station, or the UAV will land on the landing station, but outside of a tolerance region for charging the UAV's battery.

It is also known to use markers, for example, QR codes, in conjunction with the UAV's battery to direct the UAVs to designated landing stations. A major drawback is that such markers often cannot be used at night, as the UAVs' cameras cannot sufficiently detect them. Even when lighting conditions are favorable for such marker use, detecting these markers requires the UAVs to be equipped with reasonably high resolution cameras, which increases cost and processing resources. Further, the codes may need to be quite large to be detected by the UAVs from a significant distance, which may be impractical and/or ascetically unpleasing. In addition, the use of QR codes tends to lose effectiveness in large-scale employments, such as in a UAV light show with potentially thousands of UAVs.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1 shows an unmanned aerial vehicle 100 in a schematic view, according to various aspects;

FIG. 2 shows complementary configurations of the UAV and a landing pod according to one aspect of the disclosure;

FIG. 3 shows a light marker within a landing pod, according to an aspect of the disclosure;

FIG. 4 shows dimensions of ae landing pod and UAV according to an aspect of the disclosure;

FIG. 5 shows a landing station as a plurality of landing pods, according to an aspect of the disclosure;

FIG. 6 depicts a bandpass filter as utilized with received light from a light marker;

FIG. 7 depicts a frame of image sensor data following filtering with the bandpass filter;

FIG. 8A depicts the landing station and cluster of six landing pods;

FIG. 8B depicts the first row as received by the processor;

FIG. 8C depicts the comparison of a first row with a second row from the same frame;

FIG. 8D depicts a bright spot as two bright lines in adjacent rows;

FIG. 9A depicts six detected bright spots in a first frame;

FIG. 9B depicts a cluster of six bright spots;

FIG. 9C depicts a superimposition of a detected bright spot and the six detected bright spots;

FIG. 10 depicts an iterative adjustment of landing trajectory based on an identified bright spot;

FIG. 11 depicts a high-level diagram of steps for processing camera image sensor data; and

FIG. 12 shows a method of unmanned aerial vehicle landing.

### DESCRIPTION

The following detailed description refers to the accompanying drawings that show, by way of illustration, specific details and aspects in which the disclosure may be practiced. One or more aspects are described in sufficient detail to enable those skilled in the art to practice the disclosure. Other aspects may be utilized and structural, logical, and/or electrical changes may be made without departing from the scope of the disclosure. The various aspects of the disclosure are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The term “exemplary” may be used herein to mean “serving as an example, instance, or illustration”. Any aspect or design described herein as “exemplary” is not necessarily to be construed as preferred or advantageous over other aspects or designs.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and in the claims expressly refer to a quantity greater than one. Accordingly, any phrases explicitly invoking the aforementioned words (e.g., “a plurality of (objects)”, “multiple (objects)”) referring to a quantity of objects expressly refers more than one of the said objects. The terms “group (of)”, “set (of)”, “collection (of)”, “series (of)”, “sequence (of)”, “grouping (of)”, etc., and the like in the description and in the claims, if any, refer to a quantity equal to or greater than one, i.e. one or more.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. Any type of information, as described herein, may be handled for example via a one or more processors in a suitable way, e.g. as data.

The terms “processor” or “controller” as, for example, used herein may be understood as any kind of entity that allows handling data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” detailed herein may be understood to include any suitable type of memory or memory device, e.g., a hard disk drive (HDD), a solid-state drive (SSD), a flash memory, etc.

Differences between software and hardware implemented data handling may blur. A processor, controller, and/or circuit detailed herein may be implemented in software, hardware and/or as hybrid implementation including software and hardware.

The term “system” (e.g., a sensor system, a control system, a computing system, etc.) detailed herein may be understood as a set of interacting elements, wherein the elements can be, by way of example and not of limitation, one or more mechanical components, one or more electrical components, one or more instructions (e.g., encoded in storage media), and/or one or more processors, and the like.

The term “position” used with regard to a “position of an unmanned aerial vehicle”, “position of an object”, “position of an obstacle”, and the like, may be used herein to mean a point or region in a two- or three-dimensional space. It is understood that suitable coordinate systems with respective reference points are used to describe positions, vectors, movements, and the like. The term “flight path” used with regard to a “predefined flight path”, a “traveled flight path”, a “remaining flight path”, and the like, may be understood as a trajectory in a two- or three-dimensional space. The flight path may include a series (e.g., a time-resolved series) of positions along which the unmanned aerial vehicle has traveled, a respective current position, and/or at least one target position towards which the unmanned aerial vehicle is traveling. The series of positions along which the unmanned aerial vehicle has traveled may define a traveled flight path. The current position and the at least one target position may define a remaining flight path.

The term “map” used with regard to a two- or three-dimensional map may include any suitable way of describing positions of objects in the two- or three-dimensional space.

An unmanned aerial vehicle (UAV) is an aircraft that has the capability of autonomous flight. In autonomous flight, a human pilot is not aboard and in control of the unmanned aerial vehicle. The unmanned aerial vehicle may also be denoted as an unstaffed, uninhabited or unpiloted aerial vehicle, aircraft or aircraft system or UAV.

The unmanned aerial vehicle, according to various aspects, may include a support frame that serves as a basis for mounting components of the unmanned aerial vehicle, such as, for example, motors, sensors, mechanic, transmitter, receiver, and any type of control to control the functions of the unmanned aerial vehicle as desired. One or more of the components mounted to the support frame may be at least partially surrounded by a shell (also referred to as body, hull, outer skin, etc.). As an example, the shell may mechanically protect the one or more components. Further, the shell may be configured to protect the one or more components from moisture, dust, radiation (e.g. heat radiation), etc.

The unmanned aerial vehicle, according to various aspects, may include a camera gimbal having an independent two- or three-axis degree of freedom to properly track a target, e.g., a person or point of interest, with a tracking camera independently of an actual flight direction or actual attitude of the unmanned aerial vehicle. In some aspects, a depth camera may be used for tracking, monitoring the vicinity, providing images to a user of the unmanned aerial vehicle, etc. A depth camera may allow the association of depth information with an image, e.g., to provide a depth image. This allows, for example, the ability to provide an image of the vicinity of the unmanned aerial vehicle including depth information about one or more objects depicted in the image.

The unmanned aerial vehicle (UAV) described herein can be in the shape of an airplane (e.g., a fixed wing airplane) or a copter (e.g., a multi-rotor copter), i.e., a rotorcraft unmanned aerial vehicle, e.g., a quad-rotor unmanned aerial vehicle, a hex-rotor unmanned aerial vehicle, an octo-rotor unmanned aerial vehicle. The unmanned aerial vehicle described herein may include a plurality of rotors (e.g., three, four, five, six, seven, eight, or more than eight rotors), also referred to as propellers. Each of the propellers has one or more propeller blades. In some aspects, the propellers may be fixed pitch propellers. The propellers may be characterized by a pressure side and a suction side, wherein the pressure side is the bottom side of the propeller and the suction side is the top side of the propeller. Propellers may have a variety of dimensions, which will be discussed throughout this disclosure. The term “height” is used herein to describe a perpendicular distance from the cord. The term “thickness” is used to describe the measurement along an axis connecting, and perpendicular to, the leading edge and the trailing edge.

The unmanned aerial vehicle may be configured to operate with various degrees of autonomy: under remote control by a human operator, or fully or intermittently autonomously, by onboard computers. The unmanned aerial vehicle may be configured to lift-off (also referred to as take-off) and land autonomously in a lift-off and/or a landing operation mode. Alternatively, the unmanned aerial vehicle may be controlled manually by a radio control (RC) at lift-off and/or landing. The unmanned aerial vehicle may be configured to fly autonomously based on a flight path. The flight path may be a predefined flight path, for example, from a starting point or a current position of the unmanned aerial vehicle to a target position, or, the flight path may be variable, e.g., following a target that defines a target position. In some aspects, the unmanned aerial vehicle may switch into a GPS-guided autonomous mode at a safe altitude or safe distance. The unmanned aerial vehicle may have one or more fail-safe operation modes, e.g., returning to the starting point, landing immediately, etc. In some aspects, the unmanned aerial vehicle may be controlled manually, e.g., by a remote control during flight, e.g. temporarily.

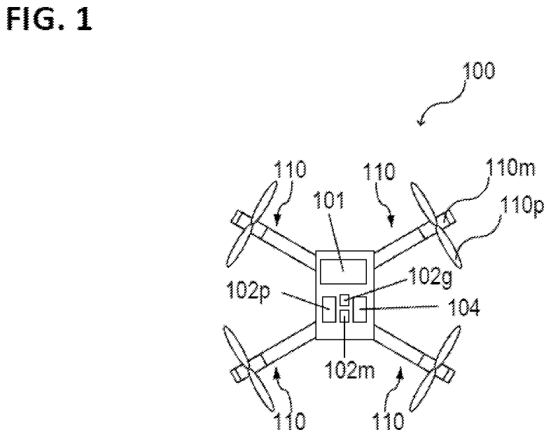

FIG. 1 illustrates an unmanned aerial vehicle 100 in a schematic view, according to various aspects. The unmanned aerial vehicle 100 may include a plurality of (e.g., three or more than three, e.g., four, six, eight, etc.) vehicle drive arrangements 110. Each of the vehicle drive arrangements 110 may include at least one drive motor 110m and at least one propeller 110p coupled to the at least one drive motor 110m. According to various aspects, the one or more drive motors 110m of the unmanned aerial vehicle 100 may be electric drive motors. Therefore, each of the vehicle drive arrangements 110 may be also referred to as an electric drive or an electric vehicle drive arrangement.

Further, the unmanned aerial vehicle 100 may include one or more processors 102p configured to control flight or any other operation of the unmanned aerial vehicle 100. The one or more processors 102p may be part of a flight controller or may implement a flight controller. The one or more processors 102p may be configured, for example, to provide a flight path based at least on a current position of the unmanned aerial vehicle 100 and a target position for the unmanned aerial vehicle 100. In some aspects, the one or more processors 102p may control the unmanned aerial vehicle 100 based on a map, as described in more detail below. In some aspects, the one or more processors 102p may directly control the drive motors 110m of the unmanned aerial vehicle 100, so that in this case no additional motor controller may be used. Alternatively, the one or more processors 102p may control the drive motors 110m of the unmanned aerial vehicle 100 via one or more additional motor controllers. The motor controllers may control a drive power that may be supplied to the respective motor. The one or more processors 102p may include or may implement any type of controller suitable for controlling the desired functions of the unmanned aerial vehicle 100. The one or more processors 102p may be implemented by any kind of one or more logic circuits.

According to various aspects, the unmanned aerial vehicle 100 may include one or more memories 102m. The one or more memories 102m may be implemented by any kind of one or more electronic storing entities, e.g., one or more volatile memories and/or one or more non-volatile memories. The one or more memories 102m may be used, e.g., in interaction with the one or more processors 102p, to build and/or store the map, according to various aspects.

Further, the unmanned aerial vehicle 100 may include one or more power supplies 104. The one or more power supplies 104 may include any suitable type of power supply, e.g., a direct current (DC) power supply. A DC power supply may include one or more batteries (e.g., one or more rechargeable batteries), etc.

According to various aspects, the unmanned aerial vehicle 100 may include one or more sensors 101. The one or more sensors 101 may be configured to monitor the vicinity of the unmanned aerial vehicle 100. The one or more sensors 101 may be configured to detect obstacles in the vicinity of the unmanned aerial vehicle 100. According to various aspects, the one or more processors 102p may be further configured to modify a predefined flight path of the unmanned aerial vehicle 100 based on detected obstacles to generate a collision free flight path to the target position avoiding obstacles in the vicinity of the unmanned aerial vehicle. According to various aspects, the one or more processors 102p may be further configured to reduce the altitude of the unmanned aerial vehicle 100 to avoid a collision during flight, e.g., to prevent a collision with a flying object that is approaching unmanned aerial vehicle 100 on a collision course. As an example, if the unmanned aerial vehicle 100 and the obstacle approach each other and the relative bearing remains the same over time, there may be a likelihood of a collision.

The one or more sensors 101 may include, for example, one or more cameras (e.g., a depth camera, a stereo camera, etc.), one or more ultrasonic sensors, one or more radar (radio detection and ranging) sensors, one or more lidar (light detection and ranging) sensors, etc. The one or more sensors 101 may include, for example, any other suitable sensor that allows a detection of an object and the corresponding position of the object. The unmanned aerial vehicle 100 may further include a position detection system 102g. The position detection system 102g may be based, for example, on global positioning system (GPS) or any other available positioning system. Therefore, the one or more processors 102p may be further configured to modify a predefined flight path of the unmanned aerial vehicle 100 based on data obtained from the position detection system 102g. The position detection system 102g may be used, for example, to provide position and/or movement data of the unmanned aerial vehicle 100 itself (including a position, e.g., a direction, a speed, an acceleration, etc., of the unmanned aerial vehicle 100). However, other sensors (e.g., image sensors, a magnetic sensor, etc.) may be used to provide position and/or movement data of the unmanned aerial vehicle 100. The position and/or movement data of both the unmanned aerial vehicle 100 and of the one or more obstacles may be used to predict a collision (e.g., to predict an impact of one or more obstacles with the unmanned aerial vehicle).

According to various aspects, the one or more processors 102p may include (or may be communicatively coupled with) at least one transceiver configured to provide an uplink transmission and/or downlink reception of radio signals including data, e.g., video or image data and/or commands. The at least one transceiver may include a radio frequency (RF) transmitter and/or a radio frequency (RF) receiver.

The one or more processors 102p may further include (or may be communicatively coupled with) an inertial measurement unit (IMU) and/or a compass unit. The inertial measurement unit may allow, for example, a calibration of the unmanned aerial vehicle 100 regarding a predefined plane in a coordinate system, e.g., to determine the roll and pitch angle of the unmanned aerial vehicle 100 with respect to the gravity vector (e.g., from planet earth). Thus, an orientation of the unmanned aerial vehicle 100 in a coordinate system may be determined. The orientation of the unmanned aerial vehicle 100 may be calibrated using the inertial measurement unit before the unmanned aerial vehicle 100 is operated in flight mode. However, any other suitable function for navigation of the unmanned aerial vehicle 100, e.g., for determining a position, a velocity (also referred to as flight velocity), a direction (also referred to as flight direction), etc., may be implemented in the one or more processors 102p and/or in additional components coupled to the one or more processors 102p. To receive, for example, position information and/or movement data about one or more obstacles, the input of a depth image camera and image processing may be used. Further, to store the respective information in the (e.g., internal) map of the unmanned aerial vehicle 100, as described herein, at least one computing resource may be used.

The unmanned aerial vehicle 100 may be referred to herein as UAV. However, a UAV may include other unmanned vehicles, e.g. unmanned ground vehicles, water vehicles, etc. In a similar way, the UAV may be any vehicle having one or more autonomous functions that are associated with a control of a movement of the vehicle.

However, various autonomous operation modes of a UAV may require a knowledge of the position of the UAV. Usually, the position of the UAV is determined based on GPS (Global Positioning System) information, e.g., Real Time Kinematic (RTK) GPS information. However, there may be many areas where an autonomous operation of a UAV may be desired (for inspections, rescue operations, etc.) but where the GPS information is either not available or faulty. As an example, various structures (e.g., a bridge, a building, etc.) may shield the GPS signals, so that it may not be possible for a UAV to determine its location. As another example, reflections from a water surface may disturb the GPS signals and make a GPS system of a UAV at least temporarily useless. Therefore, it may be difficult to inspect an oil platform on the ocean with an autonomously operating UAV. As another example, in other locations such indoors, in tunnels, in a cave, below earth, etc., there may be no GPS signals available which usually excludes many inspection cases with obstacle avoidance from effective use by customers.

UAVs may be configured as multirotor helicopters, such as, for example, quadcopters and octocopters. The specific number of propellers used for the UAV is largely immaterial to the embodiments disclosed herein, which can be implemented in a quadcopters UAV, an octocopter UAV, or otherwise, without limitation. These multirotor-helicopter-type UAVs typically utilize multiple pairs of identical, fixed-pitched propellers, which may be configured to rotate in opposite directions. Such UAVs are able to independently control the rotational velocity of each propeller to control movement of the UAV. By changing the velocity of one or more of the various propellers, it is possible to generate a desired total thrust; to locate for the center of thrust both laterally and longitudinally; and to create a desired total torque or turning force. By increasing the thrust of its rotors operating in a first direction compared to those operating in an opposite direction, the UAV is able to create a yaw movement. A UAV may increase its thrust in one or more rotors and concurrently decrease its thrust in a diametrically opposite rotor to adjust its pitch or roll. In addition to controlling their vertical and horizontal movement, such UAVs are also capable of generally maintaining a given position in the air, with little or no horizontal or vertical change, i.e., hovering.

By using lights, such as, for example, Infrared (IR) Light Emitting Diodes (LEDs) in landing pods, a camera system in the UAV, software control algorithms, and/or suitable mechanical design of the UAV and landing pod, it is possible for a UAV to automatically steer itself and land directly on a landing pod. This system may function both at day and at night and may function for a single UAV, multiple UAVs, and/or a swarm of UAVs (such as hundreds or thousands of UAVs). This may be particularly relevant when performing UAV light shows. This UAV landing system may be utilized day or night, and it may function for even very large numbers of UAVs, which may be particularly relevant when performing UAV light shows.

A UAV light show may utilize hundreds or thousands of UAVs at a given time. Moreover, many additional UAVs may be employed in reserve to continue a light show when the batteries of active UAVs become exhausted. In this manner, a first group of UAVs may begin a show, and then when the batteries of one or more of the UAVs become depleted, these one or more UAVs may land and be replaced by one or more additional UAVs from the reserve stock. This procedure of cycling UAVs may be repeated essentially indefinitely, depending on the desired length of the light show and the number of UAVs available. As such, the operation of a UAV light show may involve landing and charging many thousands of UAVs. Given the multitude of potential UAVs, it becomes desirable to reduce manual labor and/or intervention, such as by automatically bringing a landed UAV to a charging station, or repositioning a UAV that has landed on a charging station but which has failed to land with sufficient proximity to the station's charging contacts to permit charging to occur. Even a minor adjustment involving just a few seconds—such as the need to move or reposition a landed UAV—can result in at least several man-hours of labor when extrapolated across thousands of UAVs.

To reduce the quantity of manual input needed, a UAV landing system is proposed herein. This landing system may include any, or any combination, of the following components: (1) a mechanical design of the UAV and the landing pod that facilitates connection to the landing pod's charger; (2) use of electromagnetic radiation emitting elements as landing markers; (3) one or more UAV image sensors; and (4) one or more control processes for locating and navigating the UAV toward the landing pod.

Because the UAV landing system disclosed herein operates with a high degree of reliability, it is possible to perform “continuous” UAV light shows, i.e., wherein UAVs are in the air and performing the show for hours and/or days, and these UAVs are occasionally replaced as the batteries of the performing UAVs become depleted. In a UAV light show, the UAVs may be configured such that they land and begin charging when their batteries start to become depleted. Concurrently or simultaneously, another UAV may take its place.

To facilitate the UAVs' automatically establishing connection to their charging elements upon landing, it may be desirable to utilize a design of both the UAVs and the charging pods to mechanically facilitate this connection.

In this manner, the UAVs may be configured with a body design that physically complements a shape of the landing pod. That is, the landing pods may be configured as a recessed region of a landing station. The landing pods may be designed such that a UAV landing generally in the landing pod (whether directly in the middle of the pod, offset from the middle of the pod, principally along a side wall of the pod, along an upper edge of the pod, or even along an upper rim of the pod) will be caused by gravity to slide into the landing pod and reach a desired location within the landing pod in which the UAV makes connection with the landing pod's charging elements. In this manner, the UAV may be configured with its lateral center of gravity situated generally within the middle of the UAV, and/or wherein the center of gravity is situated low within the UAV's central control element. In this manner, a UAV is afforded a large landing tolerance, such that a UAV landing near a central region of the landing pod will slide into the central region in which charging occurs. The UAV and landing pod may be structured such that the natural resting position of the UAV within the landing pod is also a region in which the UAV is charged from the charging pod. In this manner, the UAV can slide into the charging position without additional manual repositioning.

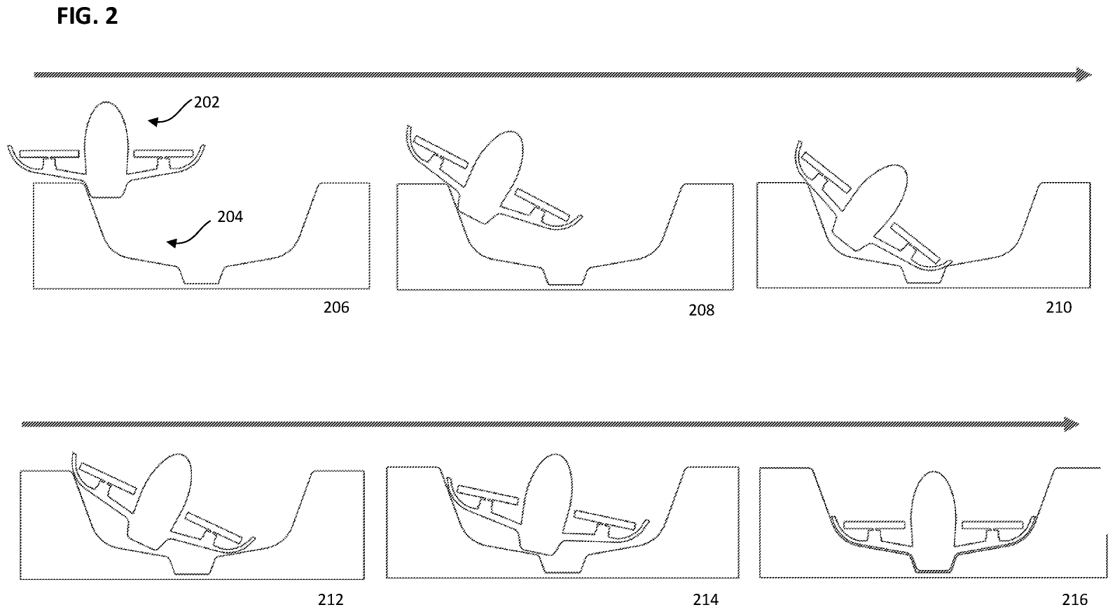

FIG. 2 shows the complementary configurations of the UAV and the landing pod according to one aspect of the disclosure. That is, FIG. 2 depicts how the motor arms of the UAV and the specific funnel shape of the landing pod work together to guide the UAV the last distance toward the bottom of the landing pod to the region where the UAV can be charged. In this figure, the UAV 202 and the landing pod 204 have complementary shapes. A UAV 202 may be unable to direct itself into the middle of the landing pod; however, a UAV that lands generally within a vicinity of the landing pod 204 may be caused to slide into the desired position. In 206, the UAV has landed along the upper shoulder of the landing pod. This UAV is caused by gravity to descend past the upper edge of the landing pod 208, toward the bottom outer edge of the landing pod 210, toward the center of the landing pod 212, along the shoulder of the inner region of the landing pod 214, and into the charging position in the center of the landing pod 216.

The landing pods may be configured with a light marker, which may be used to provide an electromagnetic signal to the UAVs, which may allow the UAVs to guide themselves to the charging pods in the manner described herein.

According to one aspect of the disclosure, the light marker may include a light source that is configured to emit light. In at least one embodiment, the light is IR light. According to an aspect of the disclosure, the IR light source may be one or more LEDs.

The landing pod may be configured with one or more light markers in its center charging well, which may be designed to direct a UAV to land in or near a center region of the landing pod. The one or more light markers may be placed such that they will be covered by a UAV when the UAV lands and docks within the landing pod. In this manner, and specifically by covering the one or more light markers, other UAVs will be unable to detect the one or more light markers in that landing pod, and thus the other UAVs will seek other landing pods for landing.

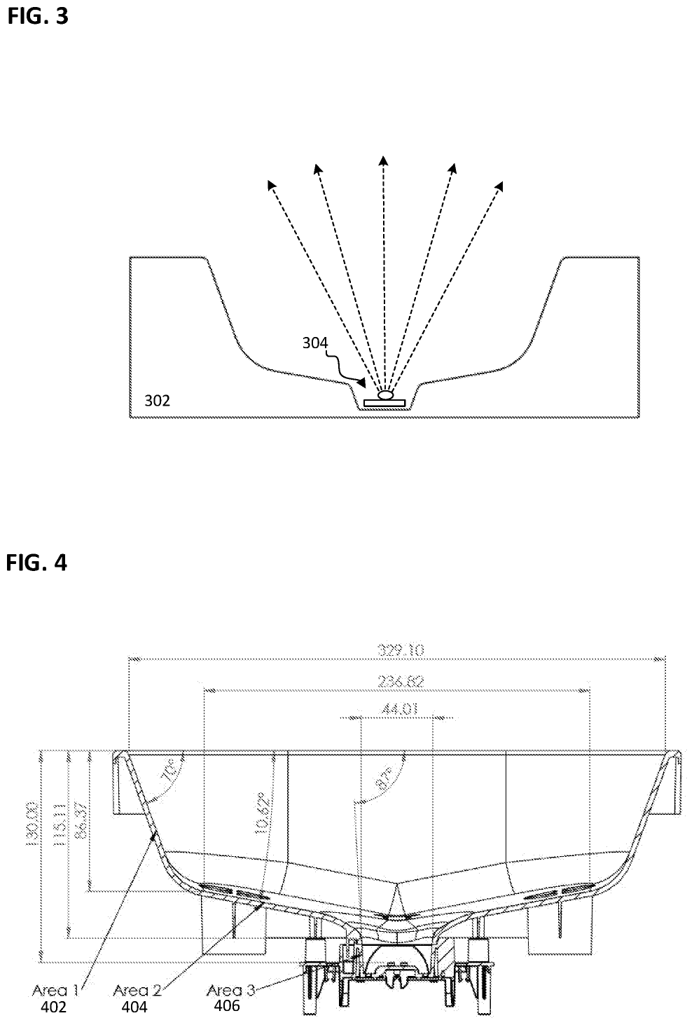

FIG. 3 shows a light marker within a landing pod, according to an aspect of the disclosure. In this figure, the landing pod is shown as 302 and is configured in the fashion described above. Within the landing pod 302 is a light marker 304. The light marker may be any light source whatsoever that is capable of transmitting light in a generally upward direction. The light transferred may be visible or invisible, although under certain circumstances, such as a UAV light show, light transmitted along the invisible spectrum may be preferred. According to one aspect of the disclosure, the light marker may be configured to emit infrared light. Depending on the configuration, the light marker may be configured to emit exclusively infrared light, such that the spectrum of light emitted is invisible or generally invisible to the human eye, and such that the light is emitted at a sufficiently limited electromagnetic range as to be readily filterable by a bandpass filter. In this figure, the light marker is depicted as being at the bottom area of the well of the landing pod 302. Under certain circumstances, it may be advantageous to place the lighting marker in this location, as it is central to the landing pod and is unlikely to be obstructed by the landing pod's physical features, such as walls. Nevertheless, the light marker may be placed in any location along the landing pod, and the position depicted herein is not intended to be limiting.

FIG. 4 shows a possible configuration of the landing pod according to an aspect of the disclosure. It is expressly noted these dimensions are only one possible configuration for implementing the concept disclosed herein. The present concept may be executed using a variety of size and shape configurations. As such, the dimensions depicted in FIG. 4 are not intended to be limiting and should not be conceived of as such. The landing pod may be generally circular and generally funnel shaped. The landing pod may be generally configured with three areas: a first area 402, a second area 404, and a third area 406. The first area 402 may be generally configured as a pre-guiding area. This pre-guiding area 402 may delineate an area of the landing pod. The pre-guiding area 402 may be sized to accommodate an outer perimeter or outer circumference of the UAV. The pre-guiding area 402 may be sized only larger than an outer perimeter or outer circumference of the UAV such that a UAV landing within a tolerance outside of a central region of the landing pod may be caused to slide into a central area of the landing pod. According to an aspect of the disclosure, the first area 402 may be sized to be from 100 millimeters (mm) to 60 mm larger than an outer portion of a UAV. The first area 402 may comprise a material or a surface that permits sliding of the UAV. That is, the first area 402 may be configured to have a sufficiently low friction coefficient that the UAV can slide along an inner portion of first area. A curvature and/or angle of the first area 402 may be selected to ensure that the UAV moving along the first area always tilts toward a center of the landing pod. The second area 404 may be configured to be less steeply angled than the first area 402. According to an aspect of the disclosure, the second area 404 may be configured with a downward slope (toward the middle of the landing pod) at approximately 10 degrees. The exact downward slope may be chosen based on various factors including, but not limited to, any of material, friction coefficient, weight of the UAV, or any combination thereof. It may comprise a material that permits the UAV to slide along its surface. The second area 404 may be configured to guide the UAV toward area three 406 while preventing an undesired portion of the UAV from entering and/or becoming stuck in area three 406 (such as preventing a propeller or a propeller support from becoming stuck in area three 406). Area two 404 may be configured to reduce a movement of the UAV. According to one aspect of the disclosure, area two 404 may restrict the area of the UAV from approximately +/−60 mm to +/−5 mm. Area three 406 may be configured as a central or inner-most portion of the landing pod. This area may be configured to house a central or base portion of the UAV. It may comprise a material that may allow the UAV to slide along its surface. Area three 406 may be generally cylindrical. The lateral walls of area three 406 may be generally vertical. Area three 406 may be configured to reduce a possible movement of the UAV from approximately +/−5 mm to approximately +/−1 mm. The general configurations of area one 402, area two 404, and area three 406 may be selected to prevent tipping of the UAV and to ensure that no portion of the UAV becomes stuck in an unintended region or area during landing. By partitioning the landing pod into these three areas, each with progressively smaller tolerances, a larger positioning tolerance for landing can be achieved.

The landing pods may be used for both landing and launching. That is, the UAVs may be placed in the landing pods before operation (such as, for example, before a UAV light show), and the UAVs may then be launched from a resting position within the landing pods.

The landing pods may be grouped together to provide a landing station that includes multiple landing pods. For example, a landing station may be configured to include two landing pods, four landing pods, six landing pods, eight landing pods, ten landing pods, or other numbers. The number of landing pods may be any number and may be determined based on at least the number of UAVs for a given purpose or show; a desired concentration of UAVs, portability of the UAVs and/or the pods; space available for launch and/or landing; or any combination thereof.

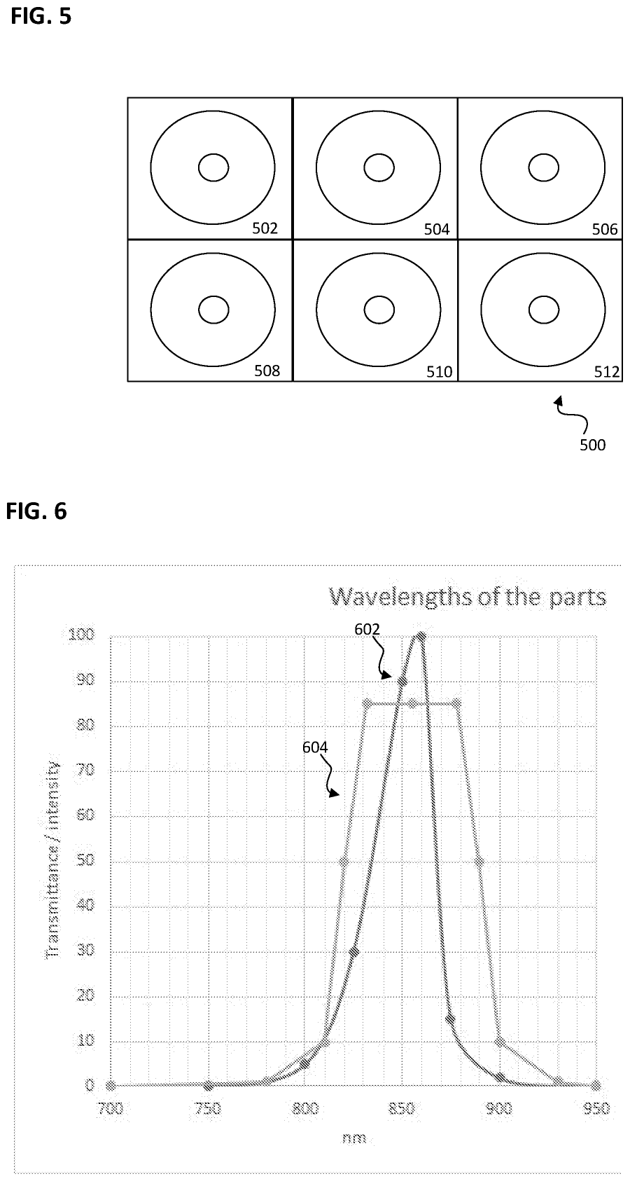

FIG. 5 shows a landing station 500 as a plurality of landing pods 502-512, according to an aspect of the disclosure. In this example, a plurality of landing pods 502-512 are grouped together to form a landing station 500. The landing station 500 in this case consists of six landing pods, although any number of landing pods may be combined to create a landing station. The landing pods may have a known shape, including a known length, width, and height. The landing pods may be combined in a known shape or configuration. As will be described herein, the known shape or configuration of the landing pods to create the landing station 500 may be utilized in light marker detection, wherein a plurality of light markers detected with a relationship corresponding to the relationship of the landing pods may be detected as a landing station.

In addition, the landing pods may be configured with one or more sensors to detect that a UAV has landed in the landing pod. This can be any type of sensor without limitation. According to one aspect of the disclosure, this may be a sensor that is configured to detect an electrical connection between the UAV and the charging element of the landing pod. In this manner, the light marker will be turned off when the UAV lands in the landing pod.

In the case of an IR LED, the LED used for guiding the UAV to the pod may be mounted in the center of each pod. The LED may be a conventionally available LED, such as an off-the-shelf component.

Once a UAV has landed in a pod, it will block the IR light from the LED. This prevents other UAVs from trying to land in the same pod. To completely ensure that no stray light from the LED can be seen by other UAVs, and also to save power, circuitry in the pod electronics may automatically turn off the LED when a UAV has landed.

In some UAV applications, such as in the implementation of UAV light shows, for example, there may otherwise be limited or no utility to the UAV having a camera, and UAVs for such light shows may not otherwise be equipped with a camera. Although the methods and principles of detecting a landing pod using a light marker disclosed herein may require an image sensor, they are designed to be able to be performed with a simple, low-cost and lightweight camera.

According to one aspect of the disclosure, the UAV may be equipped with a camera that is of video graphics array (VGA) resolution, is monochrome (i.e., does not contain any color Bayer filter) and is capable of outputting at least 60 frames per second. The camera may have a wide Field of View (FoV) and a narrow band-pass IR filter.

The narrow band-pass filter may be selected in conjunction with the light source of the light marker. For example, and according to one aspect of the disclosure, the LED may be configured to output infrared light at approximately a peak 850 nanometer wavelength. The UAV may then be configured with an 850 nm narrowband IR pass filter.

FIG. 6 depicts a bandpass filter as utilized with receive light from a light marker. In this manner, infrared LED light from a light marker 602 is received by the camera sensor. That is, the UAV is equipped with a camera, which includes a light sensor and one or more lenses. Light enters the camera through the lenses and is detected by the light sensor. The results are processed through a bandpass filter. The filter may be configured to eliminate some or all data corresponding to wavelengths that do not come from light emitted by the light marker. In this case, the light marker emits infrared light, which is depicted as 602. The bandpass filter 604 is configured to eliminate data for light outside of the infrared light emitted by the light marker. In this manner, only infrared light remains. This infrared light may be detected and processed in the manner described herein.

Outdoor sunlight includes considerable energy ranging from short wave visible light (˜400 nm) to near-IR wavelengths (1000 nm). Left unfiltered, the camera's sensor will be sensitive to most or all of these wavelengths, which may reduce the effectiveness of the light marker sensing during daylight. To address this problem and thus to improve performance, an 850 nm narrowband IR pass filter may be employed. In this manner, only light at or near 850 nm is directed to the camera's sensor. Ideally, the detected light in this range corresponds only to the light markers. However, even in daylight situations where sunlight in this general range may also be present, testing indicates that sufficient contrast between the portions of the sunlight that pass through the filter and the light emitted by the light markers exists, such that the UAV can still distinguish between the light markers and background light, such as light from the sun.

According to another aspect of the disclosure, the camera may be selected or configured to be sensitive only to a wavelength or to the wavelengths that are emitted by the light markers. That is, if the light markers are configured to emit IR light, the cameras may be selected or configured to only be sensitive to IR light.

The cameras may be mounted in a downward facing direction on the UAV. That is, the camera may be mounted on an underside of the UAV or otherwise directed such that it generally faces the Earth in a normal flying or hovering configuration.

According to any aspect of the disclosure, the camera module used may be a small lightweight camera module. The camera may be configured without an infrared cut filter, but instead include an infrared bandpass filter. The IR bandpass filter may be included in the module to let through only the wavelength of the infrared LED in the landing pod, which allows the system to function at night and during the day.

The camera may be configured to have a wide field of vision (FoV). The wide FoV may be required to allow the UAV to fly at a tilted angle. This may be desired at least because a tilted flying angle is how a UAV behaves in windy conditions or how a UAV makes rapid movements. Using a camera with a 90 degree FoV, for example, allows the UAV to tilt 45 degrees while still being able to see the target LED straight below.

The field-of-view of the camera may be maximized (to around 90 degrees) to allow the camera to continuously see the landing LED spots even when the UAVs must tilt significantly in order to steer/stay in place due to high winds.

The camera may be configured for a predetermined frame rate. A faster frame rate may result in increased accuracy in locating the light marker but may require additional processing power. A slower frame rate may economize processing power but result in decreased accuracy. According to one aspect of the disclosure, the frame rate may be 60 frames per second. The frame rate may be adjusted as desired and should not be understood as being limited to 60 frames per second.

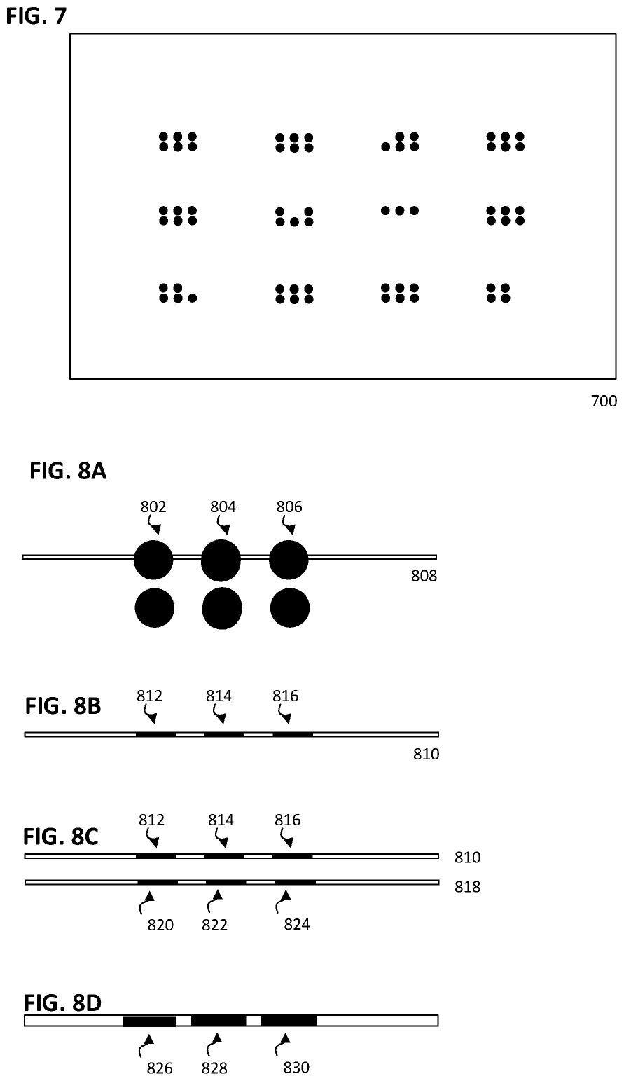

FIG. 7 depicts a frame of an image sensor data following filtering with the bandpass filter as described above 700. In this manner, it is anticipated that only information corresponding to the wavelength or wavelengths emanated from the light markers are depicted. This frame depicts twelve landing stations, each landing station arranged with six landing pods, as described above. Of the twelve clusters of landing stations depicted in this figure, some of the twelve have six dots, representing six available landing pods. Other landing stations are depicted with fewer than six landing pods, indicating that a UAV has already landed in the landing pod, and thereby the light marker is covered or deactivated.

The UAV may be equipped with one or more processors to receive and process the camera data for at least the purpose of detecting a light marker and navigating toward it. According to one aspect of the disclosure, the one or more processors may be one or more low-cost and/or low-power processors. Such low-cost and/or low-power processors may be used at least because of the processes for detecting and navigating toward the light markers, as will be described herein.

Such processors may be configured to detect and navigate toward light markers using direct memory access (DMA) memory. Because of the simplified nature of the calculations, such procedures may be carried out in conjunction with the DMA transfers, rather than requiring additional memory units to store the related data.

A first process includes generation of a data structure of the light marker positions from the camera data. This first process may permit detection of the light marker positions directly from the DMA input double-buffers, rather than requiring storage of the entire raw video frame in memory and thus permits the avoidance of external memory for the microcontroller, which may reduce both costs and board space. This may also result in increased processing speed of the process, which may better enable the processing of data at the predetermined framerate, such as, for example, 60 frames per second.

A second process tracks the detected position of the light marker from one frame to another. Depending on the number of UAVs and light markers used, the UAV may see several light markers in a given frame, perhaps tens of light markers or more. As the UAV approaches for landing, the positions, orientations, and/or relative distances of the light markers may change from frame to frame, and the UAV must be capable of homing in on the same light marker. The second process, also referred to herein as the spot tracking process, is fast enough to run in the blanking time of the camera. In testing the camera data acquisition in one embodiment, the first process and second process were all successfully simultaneously or concurrently executed on an STM32H7 single-core ARM Cortex M7 processor running at 400 MHz. Other similar processors may be used in other embodiments.

As an initial matter, and according to one aspect of the disclosure, the landing station positions may be derived from UAV GPS or other position system readings at or prior to launch. The UAVs may transmit these GPS positions to a central processor. Each of these positions may be considered a candidate landing position. Every UAV may be assigned a landing position. These assigned landing positions may be based on the GPS readings from at or before launch.

This light marker position generation process will be described using the following terms: Bright pixel, bright lines, and bright spots. Bright pixel should be understood herein as a pixel with a brightness more than a predetermined pixel brightness threshold. A bright line should be understood herein as a sequence of consecutive bright pixels located on a single row inside the frame. A bright spot should be understood herein is a sequence of two or more overlapping bright lines from neighboring rows.

The light marker position generation process may receive frame data row by row via DMA interrupts. Accordingly, the processing may be performed dynamically each time when a new pixel row is received from the sensor and a DMA interrupt is triggered.

During execution, the light marker position generation process may operate with two line arrays, characterized as the current line array and the previous line array. The line arrays are generally formed from bright lines found in corresponding rows. After each iteration, the current array becomes the previous array and a new current is ready to be processed.

One iteration of this process may include the following steps:

First, a current row is received and each bright line in the current row is detected. The locations of the detected bright lines are placed in a current bright line array and each bright line is assigned a zero spot index. A zero spot index should be understood to be an indicator that the line is not currently associated with any bright spot.

Second, the process is iterated through each possible line pair by evaluating a given line from the current array and a line from the previous array, according to the following rules. If the lines do not overlap, they are ignored and the next set of detected lines is evaluated. If the lines overlap, the spot indexes associated with each of these lines are evaluated. If both spot indexes are zero, then a new bright spot is created and associated with both lines. The border of that spot is a minimal rectangle covering the two lines. If just one of the spot indexes is zero, then the zero spot index is associated with the non-zero spot index from the other line. The borders of the bright spot may be expanded so that the border covers both of these two bright lines. If both bright spots are non-zero, then it is first determined whether both bright spots are the same. If they are the same, no action is taken. If they are not the same, then the two existing bright spots are merged. To merge the bright spots, the bright spot with the bigger spot index is replaced by the bright spot with the smaller spot index. The entry with the bigger spot index is then erased from the global spots array, and that array is shifted by one starting from the erased index. This maintains consistency in the global spots array. Furthermore, the previously found bright lines may be checked and re-indexed if their associated spot index exceeds the erased spot index. The borders of the resulting merged spot are the maximum of both borders. After the last row is processed, there will be an array of bright spots with consecutive indexes.

According to one aspect of the disclosure, a predetermined number of maximum spots may be set. In this manner if the number of spots exceeds the predetermined number of maximum spots, then further bright spots will not be created. This may be desirable to limit the memory usage for storing bright spots.

FIGS. 8A through 8D show the light marker position generation process according to an aspect of the disclosure. FIG. 8A depicts the landing station and cluster of six landing pods from the top left of FIG. 7. Of the six landing pods, the top three are indicated as 802, 804, and 806, respectively. A row of a first frame is depicted as 808. It can be seen that the row of the first frame includes image data from the three landing pods 802, 804, and 806. FIG. 8B depicts the first row 808 as it is received by the processor. The portions where the three landing pods 802, 804, and 806 are depicted are shown as black marks running through line 810, as 812, 814, and 816, respectively. These black marks represent the presence of a light marker. They may each correspond to multiple pixels and therefore may be referred to as bright lines. Each bright line may be assigned a zero-spot index. FIG. 8C depicts the comparison of row 810 from FIG. 8B with a second row (a next row) from the same frame 818. In this case, the second row 818 contains three bright lines, 820, 822, and 824, which also correspond to the light marker regions, as the detected light markers are sufficiently large to cover multiple rows. It is evaluated whether 812, 814, and 816 overlap or are adjacent to 820, 822, and 824, respectively. In this case, they are each found to overlap or be adjacent. Since they overlap or are adjacent, each overlapping/adjacent pair is assigned a new spot identifier. The border of the spots is a minimal rectangle to encompass 812 and 820 (depicted as 826), a minimal rectangle to encompass 814 and 822 (depicted as 828), and a minimal rectangle to encompass 816 and 824 (depicted as 830). Each of 826, 828, and 830 has a unique identifier, and the previous identifiers associated with 812, 814, 816, 820, 822, and 824 are deleted. In the event that any of these six bright lines has a non-zero-spot identifier, the non-zero spot identifier (the largest of the two identifiers) may be used for the identifiers for 826, 828, and 830, as described above. FIG. 8D depicts the identification of a bright spot from two bright lines on adjacent rows. In this case, the bright lights 812 and 820 have been combined as bright spot 826; the bright lines 814 and 822 have been combined as bright spot 828; and the bright lines 816 and 824 have been combined as bright spot 830.

In embodiments of the present invention, a spot-ID concept is used for spot tracking, so that each spot has its own unique spot-ID, which remains constant during all the time of video capture. The challenge then becomes to correctly find those IDs on each new frame. To solve that problem, the following actions are performed. A detailed description of the process used for tracking a LED spot from one frame to the next, is given below.

The coordinates of all spots on the new frame are detected. A list of the coordinates of all spots from the previous frame is stored in memory.

It is then determined which spots in the old frame and which spots in the new frame correspond to each other. For this determination, it is assumed that the subset of corresponding spots will have the least or shortest total distance between these two frames. As such, it is attempted to determine this subset as follows:

A matrix is filled with distances between each spot on the new frame, as compared to every spot seen on the previous frame.

In one embodiment, the Hungarian Algorithm is invoked to attempt to minimize the total distance between the spots. The Hungarian Algorithm is designed to solve the “assignment problem” in polynomial time. This algorithm can be used to determine pairs of spots with the smallest distance between them, such that the overall distances are minimized. The matrix is not always square, and therefore it may be necessary to make assignments from a frame with fewer spots to a frame with more spots.

Depending on the circumstances, it may be the case that there are actually different spots in two frames; however, when this occurs, they may also be assigned another spot with the least distance according to the Hungarian algorithm. It may, however, be desired to filter out such spots. To achieve this, the spot-pairs may be sorted by their distance attribute. It may be assumed that the distances between spots should not change significantly between consecutive frames. It may be further assumed that for the shift between frames, those distances should remain approximately the same. To do so, a median value of differences on that array may be determined, and all pairs having a distance greater than the median distance plus the median change in distance may be filtered out.

If the spot from the old frame already has a spot-ID, it may be assigned the same spot-ID for its pair from the new frame. If none of them have a spot-ID, both spots may be assigned a new unique ID.

Some spots may briefly disappear from the frames, such as when a UAV flies between the light marker and another UAV's camera. Because various such actions can cause the spots to briefly disappear, it may be desirable to implement a procedure to detect these “hidden” spots.

If a pair for a spot from the old frame cannot be seen, the spot may be considered as being temporarily out-of-sight. As stated above, this could occur, for example, when a light marker becomes covered by an obstacle, or when the marker has left the borders of the viewfinder. Such spots may be addressed by keeping their spot ID but marking them as hidden.

It may be desired to add this spot to the current frame so that the assignment-solving process could find the spot again if that spot appears on the next frame; however, for this, it may be important to know where the spot potentially has shifted. To calculate that potential offset, the spot-pairs as determined above can be assessed to find an average moving vector for each of the spots. Having determined the average moving vector, the vector can be added to the “hidden” spot. With the vector and the hidden spot, the hidden spot can be virtually injected into the current frame.

During the next frame, said injected “hidden” spots may be processed as normal spots, even though these spots have been designated as being “hidden.” Once a real spot appears in the frame, the real spot is assessed to determine whether the real spot corresponds to a “hidden” spot. If the real spot corresponds to the hidden spot, the “hidden” flag is removed. Furthermore, a predetermined number may be designated as a maximum tracking history. If no pair for the “hidden” spot appears during a number of frames corresponding to the maximum tracking history, then that spot is deleted and all that spot's history is cleared. These steps may permit the tracking of several spots with quite high reliability, even if some of the spots disappear from the viewfinder for a brief period of time.

It may be possible to further refine the results using at least a known configuration of a landing station. As described herein, the landing stations may include multiple landing pods, each configured to receive a single UAV. For example, the landing station may be made of six landing pods in a known configuration. Each UAV may report its occupying landing station and landing pod to a central control along with corresponding GPS positions. The GPS positions may be detected by the respective UAVs, or otherwise. Given the current UAV GPS ground positions, the central control may combine the reported assignment with the layout knowledge of the landing station to compute an improved estimate of the actual UAV and thus the pod GPS positions. In one embodiment, the distance-minimizing layout matching may be computed using Independent Component Analysis using the Iterative Closest Points method. Once the higher-accuracy position estimates are computed, these can be used for more precise landing targets, which may in turn provide a better initial lock for the camera tracking. According to another aspect of the disclosure, the one or more UAVs may be configured to determine their position when parked or landed in a landing pod. The UAVs will generally be at rest in a landing pod before and/or after a light show. Because the UAVs are generally equipped with position system sensors, such as a GPS sensor, the one or more UAVs are able to determine their position, and thus a position of the landing pod, while they are at rest within the landing pods. Due however to a margin of error in position system measurement, the determined position system positions may not be sufficiently accurate for other UAVs to reliably utilize these detected positions for later landing. The positions of the landing pods may be further refined beyond the margin of error for the positioning system by centrally processing the detected positions in light of a known configuration of the landing pods. In this manner, the one or more UAVs that are positioned within the landing pods detect their position with a positioning system (such as by using GPS) and transmit their detected positions to a central computer. That is, a central computer may be utilized to collect position information from the various UAVs within the landing pods. The central computer may be a computer on site, in a vicinity of the one or more landing pods, or remote from the one or more landing pods. According to one aspect of the disclosure, the central computer may be wired to the one or more landing pods, and may be configured to receive positional information from the UAVs via the one or more landing pods. According to another aspect of the disclosure, the central computer may be equipped with a receiver, which is configured to receive wireless transmissions from the one or more UAVs, the wireless transmissions including position information. According to another aspect of the disclosure, the UAVs may wirelessly transmit position information to a base station, which may then transmit the position information to the central computer via an internet connection, or any other known method. The central computer may be aware of the configuration of the landing pods within a landing station (for example, as in FIG. 4, the landing station may include landing pods in a 2×3 arrangement). The central computer may be preprogramed with known distances between the landing pods in the landing station. Using the known distances between the landing pods and given the received detected positions of the UAVs within the landing pods, the central computer may resolve inaccuracies within the detected positions. In this manner, the detected position system values can be improved. These improved position system values may be then utilized by one or more UAVs that are seeking a landing pod for landing.

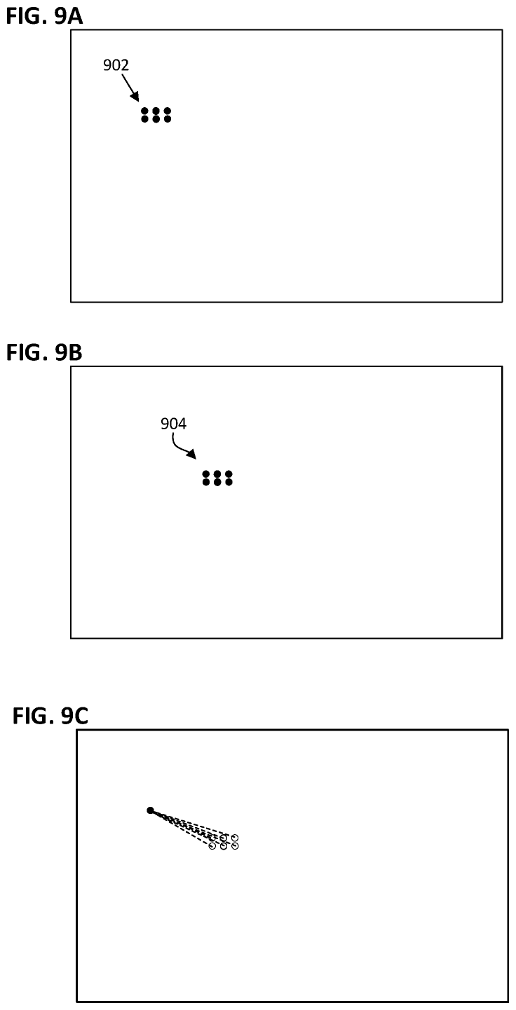

The correlation of detected bright spots between frames is depicted in FIGS. 9A through 9C. FIG. 9A depicts six detected bright spots in a first frame. These detected bright spots correspond, by way of example, to a cluster of six landing pods, which together form a landing station. By way of further example, these may be understood as the landing station at the top left portion of FIG. 7. In this explanation, particular attention will be paid to the top left bright spot in FIG. 9A, which is depicted as 902. Turning to FIG. 9B, a cluster of six bright spots 904 is also depicted. These six bright spots may correspond to the same landing station as depicted in FIG. 9A. They are shifted relative to the six bright spots in FIG. 9A, which may be due to a change in position of the UAV.

It must be determined which, if any, of the detected bright spots in the first frame and the detected bright spots in the second frame correspond to one another. For demonstrative purposes, let'sl focus only on bright spot 902 from the first frame as it relates to the detected cluster of six spots 904. FIG. 9C depicts a superimposition of detected bright spot 902 and the six detected bright spots corresponding to 904. A distance between detected bright spot 902 is calculated relative to each of the detected bright spots within 904. In one embodiment, these distances are stored in a matrix. This is repeated for each detected bright spot in FIG. 9A such that the distances between each detected bright spot in a first frame and every detected bright spot in the second frame are calculated.

It is assumed that a bright spot in a first frame and its corresponding bright spot in a second frame will be identifiable because they will have the smallest distance between the detected spots. Using this assumption, it may be possible to correlate any bright spot in the first frame with its corresponding bright spot in the second frame by employing the Hungarian algorithm.

The Hungarian algorithm, which may also be known as the Kuhn-Munkres algorithm, can be used to find maximum weight matchings in bipartite graphs, which is otherwise known as the assignment problem. The Hungarian algorithm is a known procedure and can be implemented using a variety of methods. The person skilled in the art will appreciate the Hungarian algorithm, and a person skilled in the art may select a given implementation procedure for the Hungarian algorithm without the need for further elucidation.

In one embodiment, after implementing the Hungarian algorithm, the result of the Hungarian algorithm in this case will reveal the overall shortest distances between the identified bright spots in the first frame and the identified bright spots in the second frame. It may then be assumed that each identified spot in the first frame corresponds to the identified bright spot in the second frame for which it has the shortest distance as determined in the Hungarian algorithm.

According to one aspect of the disclosure, the UAV may land at a nearest identified landing pod. According to another aspect of the disclosure, the UAV may be preprogrammed with a GPS coordinate for landing, wherein the GPS coordinate corresponds to a specific landing pod or landing station. In that case, the UAV may begin landing by steering itself toward the GPS position. The precision of the step can be enhanced via a Real Time Kinematic (RTK) GPS system. Once the UAV is sufficiently close to the landing area using GPS and/or RTK, the camera may be enabled, and the flight control functions may select one of the visible light markers that may be closest to the original landing target.

Due to factors such as GPS and accuracy, it is possible that the UAV may select and land at a target close to, but different from, the originally intended target. Nevertheless, in an environment such as a UAV light show, wherein it is expected to have many UAVs and thus many landing pods available, the selection of an adjacent or nearby landing pod is not anticipated to cause a disturbance in the landing of the UAVs.

Detected spots in the camera image may be transformed into the world frame using the UAV's current position and attitude estimate. Every spot can be on an infinite line pointing from the camera center into a direction defined by the azimuth and elevation angles seen by the camera, plus the camera's pose estimated by the UAV's attitude Extended Kalmar Filter. The flight control functions may project a similar line for the desired landing target position in the current GPS measurement frame onto the ground (zero altitude), and may select the spot in the camera image, whose corresponding line is closest to the desired landing target.

The original landing trajectory may be dynamically and iteratively changed toward the direction of the selected landing spot based on the camera image. The flight control functions do not compute a defined landing location, but rather bend the trajectory step by step to coincide with the line pointing from the camera center towards the selected landing target LED. This way, the actual distance to the target does not matter and the system is robust against position measurement errors. The bigger the angular error, the more rapidly bending can be achieved. The effect is a least square approximation of the desired landing trajectory with low pass filter characteristics. Hence, sudden changes in landing target detection or availability leads to smooth changes in flight direction.

The third process modifies the flight control to steer the UAV according to the detected landing spot. This may also include a modification to avoid excessive bumping of the UAV when the UAV reaches and makes physical contact with the landing pod.

As soon as impact with an object or ground is detected, which is measured by the angular rate sensors and accelerometers on board the UAV, the propellers may be shut off immediately. Assuming that the UAV made contact with the landing pod, the UAV will be expected to slide into the landing pod, based at least on the shapes of the UAV and the landing pod, as described above.

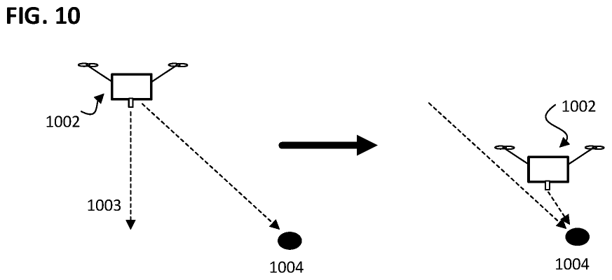

FIG. 10 depicts an iterative adjustment of landing trajectory based on an identified bright spot. In this case, the UAV 1002 is configured to travel downward along trajectory 1003 and to land. In the manner described above, the UAV 1002 detects landing spot 1004 and alters the UAV's landing trajectory such that the UAV will be able to land at 1004. The alteration of landing trajectory may be an iterative process, and thus performed stepwise to improve accuracy and correct errors. For example, following the first adjustment of the then ending trajectory, the UAV 1002, as depicted at the right side of FIG. 10 has overshot its landing trajectory as calculated on the left side of FIG. 10. As such, the landing trajectory is reconfigured, such that the UAV 1002 will be able to land at 1004. This iterative landing trajectory calculation may be performed every frame, every predetermined number of frames, at a predetermined period of time, or at any other frequency or occasion as preferred for a particular implementation.

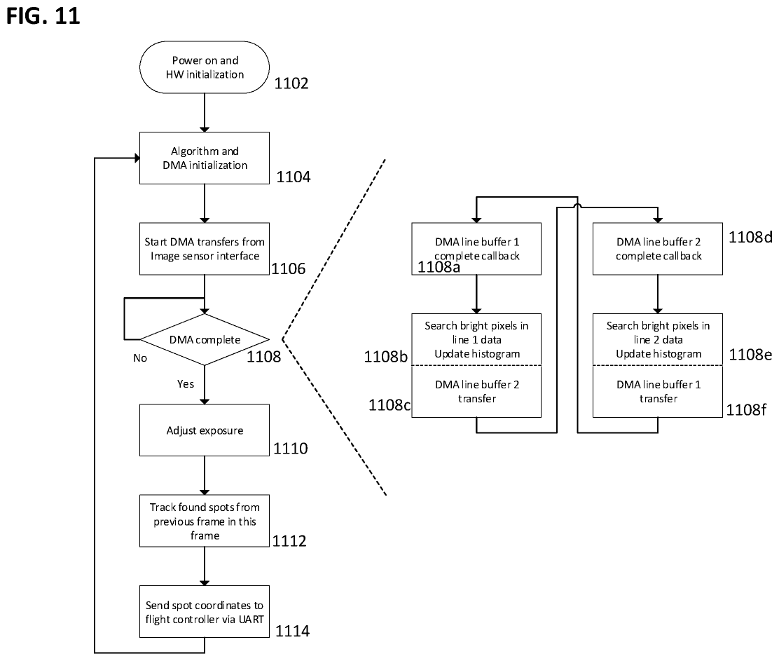

FIG. 11 depicts a high-level diagram of the processes for processing camera image sensor data. The procedure may begin with the power on and initialization of system hardware 1102. That is, the hardware related to the landing system as described herein, including but not limited to the camera (e.g. FIG. 1, 101) and any processing power necessary to perform the processes described herein, may remain powered off until a landing procedure commences. This may provide increased power efficiency. Once the hardware has been initialized, the processes and direct memory access may be initialized 1104. Thereafter, the DMA transfers from the image sensor interface may begin |1106|_{[SS1]}.

The next steps relate to direct memory access messaging as depicted in 1108. The direct memory access may be performed, for example, on the one or more memories (FIG. 1, 102m) of the UAV. The direct memory access line buffer one complete call back is performed 1108a, after which bright pixels in line 1 data are searched for and the histogram is updated 1108b. The direct memory access line buffer 2 is then transferred 1108c. The direct memory access line buffer 1108c may be simultaneously or concurrently filled with data from the image sensor interface. Thereafter bright pixels in line 2 data are searched for 1108e and the direct memory access line buffer one is filled 1108f.

Thereafter, exposure may be adjusted for the image sensor as needed based on the histogram data 1110. Found spots from the previous frame are tracked in the current frame 1112. The spot coordinates are sent to the flight coordinator 1114. The transmission of spot coordinates to the flight coordinator may be, but need not be, performed by a universal asynchronous receiver/transmitter (UART). Upon transmission of the coordinates, the process may again be iteratively employed 1104.

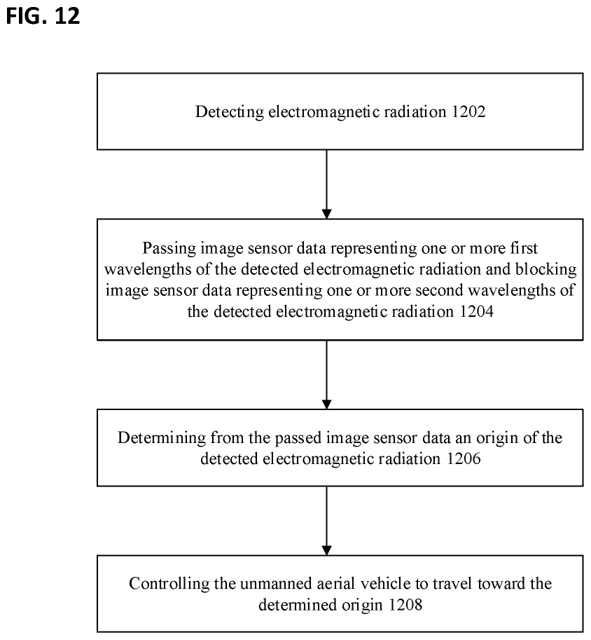

FIG. 12 shows a method of unmanned aerial vehicle flight including detecting electromagnetic radiation 1202; passing image sensor data representing one or more first wavelengths of the detected electromagnetic radiation and blocking image sensor data representing one or more second wavelengths of the detected electromagnetic radiation 1204; determining from the passed image sensor data an origin of the detected electromagnetic radiation 1206; and controlling the unmanned aerial vehicle to travel toward the determined origin 1208.

The unmanned aerial vehicle landing system may including any of a landing pod, configured in a first shape including at least one concave region, and including an electromagnetic radiation emission source, configured to emit electromagnetic radiation at one or more first wavelengths; an unmanned aerial vehicle, configured as a second shape, the second shape being generally complementary to the first shape, including an image sensor, configured to detect electromagnetic radiation and to generate image sensor data representing the detected electromagnetic radiation; a filter, configured to pass image sensor data representing the one or more first wavelengths of electromagnetic radiation and to block image sensor data representing one or more second wavelengths of electromagnetic radiation; one or more processors configured to determine from the passed image sensor data an origin of the detected electromagnetic radiation; and control the unmanned aerial vehicle to travel in the detected direction; wherein the unmanned aerial vehicle is configured to land in the landing pod, and wherein landing in the landing pod includes the first shape of the landing pod receiving the generally complementary shape of the unmanned aerial vehicle.

The one or more processors may be configured to detect a direction of the electromagnetic radiation using sensor data from the one or more sensors. Although this may be achieved in a variety of ways, a procedure is proposed herein to greatly simplify the processing power, such that electromagnetic light sources may be detected and followed using direct memory access and a small amount of processing resources. In this manner, the one or more processors may receive sensor data corresponding to a first row of the image sensor pixels. Although the image sensor may be configured to obtain image data in the context of frames, this information may be deliverable to the one or more processors in a series of rows. A first row may be delivered to the one or more processors and analyzed. To analyze the row, the one or more processors may distinguish between bright points and dark points. That is, a predefined threshold of intensity or illumination may be configured, such that pixels with a greater intensity or illumination than the predefined threshold may be considered bright points and pixels with a lower intensity or illumination than the predefined threshold may be considered dark points. Given that the bandpass filter may be configured to block electromagnetic radiation other than the electromagnetic radiation of the spectrum created by the electromagnetic radiation sources in the landing pods, the sensor data may provide only light points and dark points, wherein the light points correspond to electromagnetic emission sources in the landing pods, and wherein the dark points correspond to everything else.

Upon receiving the first row of image sensor pixels and determining bright points and dark points, the bright points may be grouped. That is, adjacent bright points may be grouped together to form bright lines. Each row may have any number of bright lines. Each bright line may be assigned an identifier.

Upon processing the first row as described above, the one or more processors may receive a second row of pixel information from the same frame. The process of the first row may generally be repeated in that, with respect to the second row, the pixels of the second row are analyzed relative to the predetermined threshold, to detect bright points and dark points. The bright points may again be grouped into bright lines and assigned an identifier.

Having detected bright lines in the first row and the second row, the detected bright lines may be compared. Herein the word “overlap” is used two describe a relationship between the detected bright lines in the first row and the detected bright lines in the second row. Because the rows are distinct and adjacent to one another overlap is understood to mean that a bright line of the first row and a bright line of the second row include pixels along the same row coordinates. For example, if a bright line in the first row included pixels ten through fifteen, and a bright line in the second included pixels eleven through sixteen, these bright lines share pixels eleven through fifteen and thus will be said to overlap. Overlapping pixels between two adjacent rows may be combined into bright spots. As described above, bright spots may be assigned a unique identifier based on the identifiers of the bright lines of which they are created.

This process of row analysis may be repeated until each row of a frame has been analyzed. Upon completion of the analysis of each row of the frame, a number of bright spots may have been identified, each bright spot ideally corresponding to an electromagnetic radiation source within a landing pod.

This procedure may be performed frame after frame, such that two or more consecutive frames have been analyzed for bright spots.

Once two or more consecutive frames have been analyzed for bright spots, the bright spots from one frame may be correlated to bright spots from another frame. To perform this correlation, it is assumed that bright spots will move only a short distance between consecutive frames.

To correlate bright spots between frames based on this assumption, a distance is calculated between each bright spot of a first frame and each bright spot of the second frame. That is, for anyone bright spot in a first frame, it is determined what the distance is between that bright spot in the first frame in every bright spot in the next frame. This is repeated for each bright spot in the first frame as it relates to every bright spot in the second frame. Having made these calculations, in one embodiment the Hungarian algorithm can be used to solve the assignment problem relative to the distances between spots. Using the Hungarian algorithm, a smallest total distance between spots of the first frame in spots of the second frame may be calculated. That is, each spot of the first frame will be matched with a single spot in the second frame, such that the spots of the first frame and the spots of the second frame are each given a single unique partner. The partners will be selected based on the total distance, such that if the distance between each of the partners is added, it will be the smallest possible distance of partner combinations.

In this manner, a spot in a first frame will be correlated to a spot in the second frame, with the assumption that the spot in the first frame and its correlated spot in the second frame each represent the same electromagnetic emission source within a landing pod.

This procedure allows a single electromagnetic radiation emission source to be selected, and that electromagnetic radiation emission source to be repeatedly selected and the UAV controlled to iteratively redirect itself to land at or near the electromagnetic radiation emission source.

The electromagnetic radiation emission source may be a source capable of emitting any spectrum of electromagnetic radiation. According to one aspect of the disclosure, the electromagnetic radiation source may emit infrared light. The electromagnetic radiation source may be configured to emit electromagnetic radiation at 850 nm.

A bandpass filter may be used to pass electromagnetic radiation from the landing pod and to block all other electromagnetic radiation. For example, in the event that the landing pod is configured to emit infrared light, the bandpass filter may be used to pass detected data corresponding to infrared light and block detected data corresponding to all other wavelengths.

In order to control the UAV to travel toward the detected magnetic radiation source, one or more processors of the UAV may be configured to determine from the image sensor data a direction or location of the electromagnetic radiation emission source.

For example, and according to one aspect of the disclosure, the image sensor of the UAV may be pointing generally downward. As such, one portion of the image data (i.e., a top portion of the image data) may be associated with a forward direction; another portion of the image data (i.e., a bottom portion of the image data) may be associated with a backward direction; another portion of the image data (i.e., a left portion of the image data) may be associated with a leftward direction; and another portion of the image data (i.e., a right portion of the image data) may be associated with a rightward direction.

In this manner, general directions may be ascertained from a location of the detected light source within the image data. For example, the farther toward the top of the image data the light source is detected, the farther forward the UAV must travel to reach the detected light source.

Based on the detected information within the sensor data, the UAV may determine an azimuth and/or an elevation angle, which may be used to control the UAV to travel toward the detected electromagnetic radiation source. The UAV may travel toward the electromagnetic radiation source by changing its direction according to the detected azimuth and/or the detected elevation angle.

The landing pod may be given a shape to accommodate landing of the UAV. According to one aspect of the disclosure, the landing pad may have a funnel shape, cone-shaped bowl shape, or otherwise. The landing pod may have a shape that is wider at the top than at the bottom. The landing pod may have a shape such that a UAV landing in or on the landing pod will be caused by gravity to fall deeper into the landing pod and come to a rest at a place where charging contacts of the UAV become electrically connected to charging contacts of the landing pod. That is, the landing pod may be physically designed to accommodate a shape of the UAV such that the UAV will naturally come to rest within the landing pod in a manner that permits charging of the UAV without the necessity for manual repositioning of the UAV.

The landing pod may be configured with multiple recesses. For example, the landing pod may be configured with a first recess and a second recess, wherein the second recess is smaller and lower than the first recess. In this manner, a UAV that generally comes to land at the landing pod will travel downward along the inner portion of the first recess until it reaches the second recess, which serves to secure the UAV into place for charging.

Because UAVs are typically designed with a central body portion from which four or eight arms extend, the propellers being along a distal portion of the arms, the landing pods may be designed to accommodate this familiar UAV structure. That is, an inner portion of the landing pod along the first recess may be wide enough to accommodate the four or six arms of the UAV, optionally along with the propellers, depending on the configuration. A second recess, having a smaller diameter than the first recess, and being lower than a bottom of the first recess, may be configured to accommodate the UAV body. The electrical contacts for charging may optionally be included in the bottom of the second recess.

In the following, various examples are described that may refer to one or more aspects of the disclosure.

In Example 1, an unmanned aerial vehicle is disclosed including an image sensor, configured to detect electromagnetic radiation and to generate image sensor data representing the detected electromagnetic radiation; a filter, configured to pass image sensor data representing one or more first wavelengths of electromagnetic radiation and to block image sensor data representing one or more second wavelengths of electromagnetic radiation; and one or more processors configured to determine from the passed image sensor data an origin of the detected electromagnetic radiation; and control the unmanned aerial vehicle to travel toward the determined origin.

In Example 2, the unmanned aerial vehicle of Example 1 is disclosed, wherein determining the origin includes determining an elevation angle and an azimuth of the origin relative to the unmanned aerial vehicle.

In Example 3, the unmanned aerial vehicle of Example 2 is disclosed, wherein controlling the unmanned aerial vehicle to travel toward the determined origin includes adjusting a flight direction of the unmanned aerial vehicle toward the azimuth and/or the elevation angle.

In Example 4, the unmanned aerial vehicle of any one of Examples 1 to 3 is disclosed, wherein the one or more processors are further configured to repeatedly determine the origin of the detected electromagnetic radiation, and to iteratively control the unmanned aerial vehicle to travel toward the determined origin based on the repeated determinations of the origin.

In Example 5, the unmanned aerial vehicle landing of any one of Examples 1 to 4 is disclosed, wherein detecting a direction of the detected electromagnetic radiation includes: receiving sensor data corresponding to a first row of image sensor pixels; determining first bright points within the first row as pixels with a brightness greater than a predetermined threshold; grouping adjacent first bright points to form first bright lines; and assigning an identifier to each first bright line.

In Example 6, the unmanned aerial vehicle of Example 5 is disclosed, wherein detecting a direction of the detected electromagnetic radiation further includes: determining second bright points within the second row as pixels with a brightness greater than a predetermined threshold; grouping adjacent second bright points to form second bright lines; and assigning an identifier to each second bright line.

In Example 7, the unmanned aerial vehicle of Example 6 is disclosed, wherein detecting a direction of the detected electromagnetic radiation further includes: determining first bright lines and second bright lines that overlap; determining bright spots as a combination of overlapping first bright lines and second bright lines, and determining an identifier for each bright spot.

In Example 8, the unmanned aerial vehicle of Example 7 is disclosed, wherein detecting a direction of the detected electromagnetic radiation further includes: determining an identifier for each bright spot includes selecting an identifier of a greatest magnitude of the first bright line and the second bright line associated with the bright spot.

In Example 9, the unmanned aerial vehicle of Examples 7 or 8 is disclosed, wherein the one or more processors are further configured to correlate a bright spot on a first frame with a bright spot on a second frame.

In Example 10, the unmanned aerial vehicle of Example 9 is disclosed, wherein the correlation of a bright spot on a first frame with a bright spot on a second frame includes determining a smallest total distance between a plurality of bright spots on the first frame and a plurality of bright spots on the second frame.

In Example 11, the unmanned aerial vehicle of Example 10 is disclosed, wherein determining the smallest total distance includes using a Hungarian Algorithm to solve an assignment problem relative to the spots in the plurality of bright spots on the first frame and the plurality of bright spots on the second frame.

In Example 12, the unmanned aerial vehicle of any one of Examples 1 to 11 is disclosed, wherein the electromagnetic emission source is configured to emit infrared light.

In Example 13, the unmanned aerial vehicle of any one of Examples 1 to 12 is disclosed, wherein the electromagnetic emission source is configured to emit electromagnetic radiation including at least wavelengths of 850 nm.

In Example 14, the unmanned aerial vehicle of any one of Examples 1 to 13 is disclosed, wherein the filter is a bandpass filter.

In Example 15, the unmanned aerial vehicle of any one of Examples 1 to 14 is disclosed, wherein the bandpass filter is configured to filter out electromagnetic radiation other than a range of electromagnetic radiation corresponding to the electromagnetic radiation emission source.

In Example 16, the unmanned aerial vehicle of any one of Examples 1 to 15 is disclosed, wherein detecting from the passed image sensor data a direction of the detected electromagnetic radiation relative to the unmanned aerial vehicle includes detecting an azimuth of the detected electromagnetic radiation.

In Example 17, the unmanned aerial vehicle of any one of Examples 1 to 16 is disclosed, wherein detecting from the passed image sensor data a direction of the detected electromagnetic radiation relative to the unmanned aerial vehicle includes detecting an elevation angle of the detected electromagnetic radiation.

In Example 18, the unmanned aerial vehicle of Example 16 or 17 is disclosed, wherein controlling the unmanned aerial vehicle to travel in the detected direction includes changing a direction of travel of the unmanned aerial vehicle according to the detected azimuth and/or the detected elevation angle.

In Example 19, the unmanned aerial vehicle of any one of Examples 7 to 18 is disclosed, wherein detecting a direction of the detected electromagnetic radiation further includes detecting a landing target as one of a plurality of bright spots in a predetermined configuration, and wherein the one or more processors are further configured to control the unmanned aerial vehicle to travel toward the landing target.

In Example 20, the unmanned aerial vehicle of any one of Examples 1 to 19 is disclosed, wherein the first shape is a funnel shape.

In Example 21, the unmanned aerial vehicle of any one of Examples 1 to 20 is disclosed, wherein the landing pod includes a first recess at a first depth and a second recess at a second depth deeper than the first depth.

In Example 22, the unmanned aerial vehicle of Example 21 is disclosed, wherein the first recess is configured to receive the unmanned aerial vehicle.

In Example 23, the unmanned aerial vehicle of Example 21 or 22 is disclosed, wherein the second recess is configured to receive a control portion of the unmanned aerial vehicle.

In Example 24, the unmanned aerial vehicle of any one of Examples 1 to 23 is disclosed, wherein the landing pod further includes one or more electrical contacts, configured to provide electrical current to the unmanned aerial vehicle.

In Example 25, the unmanned aerial vehicle of Example 24 is disclosed, wherein the one or more electrical contacts are located in or on the second recess.

In Example 26, an unmanned aerial vehicle landing system is disclosed, including: a landing pod, configured in a first shape including at least one concave region, and including an electromagnetic radiation emission source, configured to emit electromagnetic radiation at one or more first wavelengths; an unmanned aerial vehicle, configured as a second shape, the second shape being generally complementary to the first shape; wherein the unmanned aerial vehicle is configured to land in the landing pod, and wherein landing in the landing pod includes the first shape of the landing pod receiving the generally complementary shape of the unmanned aerial vehicle.

In Example 27, the unmanned aerial vehicle landing system of Example 26 is disclosed, wherein the first shape is a funnel shape.

In Example 28, the unmanned aerial vehicle landing system of Example 26 or 27 is disclosed, wherein the landing pod includes a first recess at a first depth and a second recess at a second depth deeper than the first depth.

In Example 29, the unmanned aerial vehicle landing system of Example 28 is disclosed, wherein the first recess is configured to receive the unmanned aerial vehicle.

In Example 30, the unmanned aerial vehicle landing system of Example 28 or 29 is disclosed, wherein the second recess is configured to receive a control portion of the unmanned aerial vehicle.

In Example 31, the unmanned aerial vehicle landing system of any one of Examples 26 to 30 is disclosed, wherein the landing pod further includes one or more electrical contacts, configured to provide electrical current to the unmanned aerial vehicle.

In Example 32, the unmanned aerial vehicle landing system of Example 31 is disclosed, wherein the one or more electrical contacts are located in or on the second recess.

In Example 33, an unmanned aerial vehicle landing system is disclosed including: a landing pod, configured in a first shape including at least one concave region, and including an electromagnetic radiation emission source, configured to emit electromagnetic radiation at one or more first wavelengths; an unmanned aerial vehicle, configured as a second shape, the second shape being generally complementary to the first shape, including: an image sensor, configured to detect electromagnetic radiation and to generate image sensor data representing the detected electromagnetic radiation; a filter, configured to pass image sensor data representing the one or more first wavelengths of electromagnetic radiation and to block image sensor data representing one or more second wavelengths of electromagnetic radiation; one or more processors configured to: determine from the passed image sensor data an origin of the detected electromagnetic radiation; and control the unmanned aerial vehicle to travel in the detected direction; wherein the unmanned aerial vehicle is configured to land in the landing pod, and wherein landing in the landing pod includes the first shape of the landing pod receiving the generally complementary shape of the unmanned aerial vehicle.

In Example 34, the unmanned aerial vehicle landing system of Example 33 is disclosed, wherein detecting a direction of the detected electromagnetic radiation includes: receiving sensor data corresponding to a first row of image sensor pixels; determining first bright points within the first row as pixels with a brightness greater than a predetermined threshold; grouping adjacent first bright points to form first bright lines; and assigning an identifier to each first bright line.

In Example 35, the unmanned aerial vehicle landing system of Example 34 is disclosed, wherein detecting a direction of the detected electromagnetic radiation further includes: determining second bright points within the second row as pixels with a brightness greater than a predetermined threshold; grouping adjacent second bright points to form second bright lines; and assigning an identifier to each second bright line.

In Example 36, the unmanned aerial vehicle landing system of Example 35 is disclosed, wherein detecting a direction of the detected electromagnetic radiation further includes: determining first bright lines and second bright lines that overlap; determining bright spots as a combination of overlapping first bright lines and second bright lines, and determining an identifier for each bright spot.

In Example 37, the unmanned aerial vehicle landing system of Example 36 is disclosed, wherein detecting a direction of the detected electromagnetic radiation further includes: determining an identifier for each bright spot includes selecting an identifier of a greatest magnitude of the first bright line and the second bright line associated with the bright spot.

In Example 38, the unmanned aerial vehicle landing system of Examples 36 or 37 is disclosed, wherein the one or more processors are further configured to correlate a bright spot on a first frame with a bright spot on a second frame.

In Example 39, the unmanned aerial vehicle landing system of Example 38 is disclosed, wherein the correlation of a bright spot on a first frame with a bright spot on a second frame includes determining a smallest total distance between a plurality of bright spots on the first frame and a plurality of bright spots on the second frame.

In Example 40, the unmanned aerial vehicle landing system of Example 39 is disclosed, wherein determining the smallest total distance includes using a Hungarian Algorithm to solve an assignment problem relative to the spots in the plurality of bright spots on the first frame and the plurality of bright spots on the second frame.

In Example 41, the unmanned aerial vehicle landing system of any one of Examples 33 to 40 is disclosed, wherein the electromagnetic emission source is configured to emit infrared light.

In Example 42, the unmanned aerial vehicle landing system of any one of Examples 33 to 41 is disclosed, wherein the electromagnetic emission source is configured to emit electromagnetic radiation including at least wavelengths of 850 nm.

In Example 43, the unmanned aerial vehicle landing system of any one of Examples 33 to 42 is disclosed, wherein the filter is a bandpass filter.

In Example 44, the unmanned aerial vehicle landing system of any one of Examples 33 to 43 is disclosed, wherein the bandpass filter is configured to filter out electromagnetic radiation other than a range of electromagnetic radiation corresponding to the electromagnetic radiation emission source.

In Example 45, the unmanned aerial vehicle landing system of any one of Examples 33 to 44 is disclosed, wherein detecting from the passed image sensor data a direction of the detected electromagnetic radiation relative to the unmanned aerial vehicle includes detecting an azimuth of the detected electromagnetic radiation.

In Example 46, the unmanned aerial vehicle landing system of any one of Examples 33 to 45 is disclosed, wherein detecting from the passed image sensor data a direction of the detected electromagnetic radiation relative to the unmanned aerial vehicle includes detecting an elevation angle of the detected electromagnetic radiation.

In Example 47, the unmanned aerial vehicle landing system of Example 45 or 46 is disclosed, wherein controlling the unmanned aerial vehicle to travel in the detected direction includes changing a direction of travel of the unmanned aerial vehicle according to the detected azimuth and/or the detected elevation angle.

In Example 48, the unmanned aerial vehicle landing system of any one of Examples 36 to 47 is disclosed, wherein detecting a direction of the detected electromagnetic radiation further includes detecting a landing target as one of a plurality of bright spots in a predetermined configuration, and wherein the one or more processors are further configured to control the unmanned aerial vehicle to travel toward the landing target.

In Example 49, the unmanned aerial vehicle landing system of any one of Examples 33 to 48 is disclosed, wherein the first shape is a funnel shape.

In Example 50, the unmanned aerial vehicle landing system of any one of Examples 33 to 49 is disclosed, wherein the landing pod includes a first recess at a first depth and a second recess at a second depth deeper than the first depth.

In Example 51, the unmanned aerial vehicle landing system of Example 50 is disclosed, wherein the first recess is configured to receive the unmanned aerial vehicle.

In Example 52, the unmanned aerial vehicle landing system of Example 50 to 51 is disclosed, wherein the second recess is configured to receive a control portion of the unmanned aerial vehicle.

In Example 53, the unmanned aerial vehicle landing system of any one of Examples 33 to 52 is disclosed, wherein the landing pod further includes one or more electrical contacts, configured to provide electrical current to the unmanned aerial vehicle.

In Example 54, the unmanned aerial vehicle landing system of Example 53 is disclosed, wherein the one or more electrical contacts are located in or on the second recess.

In Example 55, a method of unmanned aerial vehicle landing is disclosed including: detecting electromagnetic radiation; passing image sensor data representing one or more first wavelengths of the detected electromagnetic radiation and blocking image sensor data representing one or more second wavelengths of the detected electromagnetic radiation; determining from the passed image sensor data an origin of the detected electromagnetic radiation; and controlling the unmanned aerial vehicle to travel toward the determined origin. In Example 56, the method of unmanned aerial vehicle landing of Example 55 is disclosed, wherein determining the origin includes determining an elevation angle and an azimuth of the origin relative to the unmanned aerial vehicle.

In Example 57, the method of unmanned aerial vehicle landing of Example 56 is disclosed, wherein controlling the unmanned aerial vehicle to travel toward the determined origin includes adjusting a flight direction of the unmanned aerial vehicle toward the azimuth and/or the elevation angle.

In Example 58, the method of unmanned aerial vehicle landing of any one of Examples 55 to 57 is disclosed, further including repeatedly determining the origin of the detected electromagnetic radiation, and iteratively controlling the unmanned aerial vehicle to travel toward the determined origin based on the repeated determinations of the origin.

In Example 59, the method of unmanned aerial vehicle landing of any one of Examples 55 to 58 is disclosed, wherein detecting a direction of the detected electromagnetic radiation includes: receiving sensor data corresponding to a first row of image sensor pixels; determining first bright points within the first row as pixels with a brightness greater than a predetermined threshold; grouping adjacent first bright points to form first bright lines; and assigning an identifier to each first bright line.

In Example 60, the method of unmanned aerial vehicle landing of Example 59 is disclosed, wherein detecting a direction of the detected electromagnetic radiation further includes: determining second bright points within the second row as pixels with a brightness greater than a predetermined threshold; grouping adjacent second bright points to form second bright lines; and assigning an identifier to each second bright line.

In Example 61, the method of unmanned aerial vehicle landing of Example 60 is disclosed, wherein detecting a direction of the detected electromagnetic radiation further includes: determining first bright lines and second bright lines that overlap; determining bright spots as a combination of overlapping first bright lines and second bright lines, and determining an identifier for each bright spot.

In Example 62, the method of unmanned aerial vehicle landing of Example 61 is disclosed, wherein detecting a direction of the detected electromagnetic radiation further includes: determining an identifier for each bright spot includes selecting an identifier of a greatest magnitude of the first bright line and the second bright line associated with the bright spot.

In Example 63, the method of unmanned aerial vehicle landing of Examples 61 or 62 is disclosed, further including correlating a bright spot on a first frame with a bright spot on a second frame.

In Example 64, the method of unmanned aerial vehicle landing of Example 63 is disclosed, wherein correlating a bright spot on a first frame with a bright spot on a second frame includes determining a smallest total distance between a plurality of bright spots on the first frame and a plurality of bright spots on the second frame.

In Example 65, the method of unmanned aerial vehicle landing of Example 64 is disclosed, wherein determining the smallest total distance includes using a Hungarian Algorithm to solve an assignment problem relative to the spots in the plurality of bright spots on the first frame and the plurality of bright spots on the second frame.

In Example 66, the method of unmanned aerial vehicle landing of any one of Examples 55 to 65 is disclosed, wherein the electromagnetic emission source is configured to emit infrared light.

In Example 67, the method of unmanned aerial vehicle landing of any one of Examples 55 to 66 is disclosed, wherein the electromagnetic emission source is configured to emit electromagnetic radiation including at least wavelengths of 850 nm.

In Example 68, the method of unmanned aerial vehicle landing of any one of Examples 55 to 67 is disclosed, wherein detecting from the passed image sensor data a direction of the detected electromagnetic radiation relative to the unmanned aerial vehicle includes detecting an azimuth of the detected electromagnetic radiation.

In Example 69, the method of unmanned aerial vehicle landing of any one of Examples 55 to 68 is disclosed, wherein detecting from the passed image sensor data a direction of the detected electromagnetic radiation relative to the unmanned aerial vehicle includes detecting an elevation angle of the detected electromagnetic radiation.

In Example 70, the method of unmanned aerial vehicle landing of Example 55 or 69 is disclosed, wherein controlling the unmanned aerial vehicle to travel in the detected direction includes changing a direction of travel of the unmanned aerial vehicle according to the detected azimuth and/or the detected elevation angle.

In Example 71, the method of unmanned aerial vehicle landing of any one of Examples 64 to 70 is disclosed, wherein detecting a direction of the detected electromagnetic radiation further includes detecting a landing target as one of a plurality of bright spots in a predetermined configuration, and wherein the one or more processors are further configured to control the unmanned aerial vehicle to travel toward the landing target.

In Example 72, the method of unmanned aerial vehicle landing of any one of Examples 55 to 71 is disclosed, further including landing the unmanned aerial vehicle in a landing pod having a first recess configured to receive the unmanned aerial vehicle.

In Example 73, one or more non-transient computer readable media, configured to cause one or more processors to carry out the method of any one of Examples 54 through 72.

In Example 74, the unmanned aerial vehicle landing system of Example 25 is disclosed, further comprising a server; wherein the one or more unmanned aerial vehicles are configured to detect a position of the one or more unmanned aerial vehicle while positioned in a landing pod and to transmit the detected landing pod positions to the server; and wherein the server is configured to resolve an inaccuracy in the one or more detected positions using a known configuration of a plurality of the landing pods.

In Example 75, the unmanned aerial vehicle landing system of Example 74 is disclosed, wherein the server is configured to resolve an inaccuracy of the one or more detected positions using one or more known distances between a plurality of the landing pods.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

What is claimed is:

1. An unmanned aerial vehicle comprising:
an image sensor, configured to detect electromagnetic radiation and to generate image sensor data representing the detected electromagnetic radiation;
a filter, configured to pass image sensor data representing one or more first wavelengths of electromagnetic radiation and to block image sensor data representing one or more second wavelengths of electromagnetic radiation; and
one or more processors configured to:
determine from the passed image sensor data an origin of the detected electromagnetic radiation; and
control the unmanned aerial vehicle to travel toward the determined origin.

2. The unmanned aerial vehicle of claim 1, wherein determining the origin comprises determining an elevation angle and an azimuth of the origin relative to the unmanned aerial vehicle and adjusting a flight direction of the unmanned aerial vehicle toward the azimuth and/or the elevation angle.

3. The unmanned aerial vehicle of claim 1, wherein the one or more processors are further configured to repeatedly determine the origin of the detected electromagnetic radiation, and to iteratively control the unmanned aerial vehicle to travel toward the determined origin based on the repeated determinations of the origin.

4. The unmanned aerial vehicle landing of claim 1, wherein detecting a direction of the detected electromagnetic radiation comprises:
receiving sensor data corresponding to a first row of image sensor pixels;
determining first bright points within the first row as pixels with a brightness greater than a predetermined threshold;
grouping adjacent first bright points to form first bright lines; and
assigning an identifier to each first bright line.

5. The unmanned aerial vehicle of claim 4, wherein detecting a direction of the detected electromagnetic radiation further comprises:
determining second bright points within the second row as pixels with a brightness greater than a predetermined threshold;
grouping adjacent second bright points to form second bright lines; and
assigning an identifier to each second bright line.

6. The unmanned aerial vehicle of claim 5, wherein detecting a direction of the detected electromagnetic radiation further comprises:
determining first bright lines and second bright lines that overlap;
determining bright spots as a combination of overlapping first bright lines and second bright lines, and
determining an identifier for each bright spot.

7. The unmanned aerial vehicle of claim 6, wherein the one or more processors are further configured to correlate a bright spot on a first frame with a bright spot on a second frame by determining a smallest total distance between a plurality of bright spots on the first frame and a plurality of bright spots on the second frame.

8. The unmanned aerial vehicle of claim 1, wherein detecting from the passed image sensor data a direction of the detected electromagnetic radiation relative to the unmanned aerial vehicle comprises detecting an azimuth of the detected electromagnetic radiation and/or an elevation angle of the detected electromagnetic radiation, and wherein controlling the unmanned aerial vehicle to travel in the detected direction comprises changing a direction of travel of the unmanned aerial vehicle according to the detected azimuth and/or the detected elevation angle.

9. The unmanned aerial vehicle of claim 8, wherein detecting a direction of the detected electromagnetic radiation further comprises detecting a landing target as one of a plurality of bright spots in a predetermined configuration, and wherein the one or more processors are further configured to control the unmanned aerial vehicle to travel toward the landing target.

10. The unmanned aerial vehicle of claim 1, wherein the first shape is a funnel shape.

11. The unmanned aerial vehicle of claim 1, wherein the landing pod comprises a first recess at a first depth and a second recess at a second depth deeper than the first depth, wherein the first recess is configured to receive the unmanned aerial vehicle and wherein the second recess is configured to receive a control portion of the unmanned aerial vehicle.

12. An unmanned aerial vehicle landing system comprising:
a landing pod, configured in a first shape comprising at least one concave region, and comprising an electromagnetic radiation emission source, configured to emit electromagnetic radiation at one or more first wavelengths;
an unmanned aerial vehicle, configured as a second shape, the second shape being generally complementary to the first shape, comprising:
an image sensor, configured to detect electromagnetic radiation and to generate image sensor data representing the detected electromagnetic radiation;
a filter, configured to pass image sensor data representing the one or more first wavelengths of electromagnetic radiation and to block image sensor data representing one or more second wavelengths of electromagnetic radiation;
one or more processors configured to:
determine from the passed image sensor data an origin of the detected electromagnetic radiation; and
control the unmanned aerial vehicle to travel in the detected direction;
wherein the unmanned aerial vehicle is configured to land in the landing pod, and wherein landing in the landing pod comprises the first shape of the landing pod receiving the generally complementary shape of the unmanned aerial vehicle.

13. The unmanned aerial vehicle landing system of claim 12, wherein detecting a direction of the detected electromagnetic radiation comprises:
receiving sensor data corresponding to a first row of image sensor pixels;
determining first bright points within the first row as pixels with a brightness greater than a predetermined threshold;
grouping adjacent first bright points to form first bright lines; and
assigning an identifier to each first bright line.

14. The unmanned aerial vehicle landing system of claim 13, wherein detecting a direction of the detected electromagnetic radiation further comprises:
determining second bright points within the second row as pixels with a brightness greater than a predetermined threshold;
grouping adjacent second bright points to form second bright lines;
assigning an identifier to each second bright line;
determining first bright lines and second bright lines that overlap;
determining bright spots as a combination of overlapping first bright lines and second bright lines, and
determining an identifier for each bright spot.

15. The unmanned aerial vehicle landing system of claim 14, wherein the one or more processors are further configured to correlate a bright spot on a first frame with a bright spot on a second frame, wherein the correlation of a bright spot on a first frame with a bright spot on a second frame comprises determining a smallest total distance between a plurality of bright spots on the first frame and a plurality of bright spots on the second frame.

16. The unmanned aerial vehicle landing system of claim 12, wherein detecting from the passed image sensor data a direction of the detected electromagnetic radiation relative to the unmanned aerial vehicle comprises detecting an azimuth of the detected electromagnetic radiation and/or an elevation angle of the detected electromagnetic radiation; and wherein controlling the unmanned aerial vehicle to travel in the detected direction comprises changing a direction of travel of the unmanned aerial vehicle according to the detected azimuth and/or the detected elevation angle.

17. The unmanned aerial vehicle landing system of claim 12, further comprising a server, wherein the server is configured to receive a position of one or more unmanned aerial vehicles while positioned in a landing pod and to resolve an inaccuracy in the one or more positions using a known configuration of a plurality of the landing pods.

18. A method of unmanned aerial vehicle flight comprising:
detecting electromagnetic radiation;
passing image sensor data representing one or more first wavelengths of the detected electromagnetic radiation and blocking image sensor data representing one or more second wavelengths of the detected electromagnetic radiation;
determining from the passed image sensor data an origin of the detected electromagnetic radiation; and
controlling the unmanned aerial vehicle to travel toward the determined origin.

19. The method of unmanned aerial vehicle flight of claim 18, wherein determining the origin comprises determining an elevation angle and an azimuth of the origin relative to the unmanned aerial vehicle, and wherein controlling the unmanned aerial vehicle to travel toward the determined origin comprises adjusting a flight direction of the unmanned aerial vehicle toward the azimuth and/or the elevation angle.

20. The method of unmanned aerial vehicle flight of claim 18, further comprising repeatedly determining the origin of the detected electromagnetic radiation, and iteratively controlling the unmanned aerial vehicle to travel toward the determined origin based on the repeated determinations of the origin.

21. The method of unmanned aerial vehicle flight of claim 18, wherein detecting a direction of the detected electromagnetic radiation comprises:
receiving sensor data corresponding to a first row of image sensor pixels;
determining first bright points within the first row as pixels with a brightness greater than a predetermined threshold;
grouping adjacent first bright points to form first bright lines;
assigning an identifier to each first bright line;
determining second bright points within the second row as pixels with a brightness greater than a predetermined threshold;
grouping adjacent second bright points to form second bright lines; and
assigning an identifier to each second bright line.

22. The method of unmanned aerial vehicle flight of claim 21, wherein detecting a direction of the detected electromagnetic radiation further comprises:
determining first bright lines and second bright lines that overlap;
determining bright spots as a combination of overlapping first bright lines and second bright lines,
determining an identifier for each bright spot; and
determining an identifier for each bright spot comprises selecting an identifier of a greatest magnitude of the first bright line and the second bright line associated with the bright spot.

23. The method of unmanned aerial vehicle flight of claim 22, further comprising correlating a bright spot on a first frame with a bright spot on a second frame by determining a smallest total distance between a plurality of bright spots on the first frame and a plurality of bright spots on the second frame.
